(19) United States
(12) Patent Application Publication
(10) Pub. No.: US 2016/0055544 A1
(43) Pub. Date: Feb. 25, 2016

(54) METHOD AND SYSTEM FOR IMPROVEMENT OF INTERNET BROWSING AND ADVERTISING THROUGH ASSOCIATION OF VIRTUAL HABITATION ENVIRONMENT WITH USER-SPECIFIC WEB RESOURCES

(71) Applicant: Artem Fedyaev, San Francisco, CA (US)

(72) Inventor: Artem Fedyaev, San Francisco, CA (US)

(21) Appl. No.: 14/641,385

(22) Filed: Mar. 7, 2015

Related U.S. Application Data
(60) Provisional application No. 61/950,097, filed on Mar. 8, 2014.

(51) Int. Cl. G06Q 30/02

(52) U.S. Cl. CPC G06Q 30/0277

(57) ABSTRACT

The invention describes and claims computer-implemented method for improvement of Internet browsing and advertising through association of furnishing objects in virtual habitation environment with user-specific web resource compilations. The method comprises the steps of establishing a plurality of databases and providing customizable virtual habitation environment, with at least one virtual representation of at least partially-enclosed living space. The method further comprises the steps of providing a plurality of furnishing objects, wherein at least some of the furnishing objects are, interactive, customizable, and are advertisement objects, and may be virtual representations of actual commercially-available products. The invention teaches positioning at least some furnishing objects over the virtual representation of the at least partially-enclosed living space; associating at least some of the plurality of furnishing objects with the user-specific web resources; and allowing for user interaction with at least some of the plurality of furnishing objects.

### PRIORITY

This application claims priority to the provisional application No. 61/950,097 for MYWEBROOM SYSTEM AND METHOD, filed on 8 Mar. 2014.

### BRIEF DESCRIPTION OF THE DRAWINGS

FIG. 1 illustrates a virtual representation of the unfurnished Room 16 of one of the preferred embodiments of the present invention.

FIG. 2 illustrates the virtual representation of the Room of FIG. 1, furnished with a plurality of objects 44.

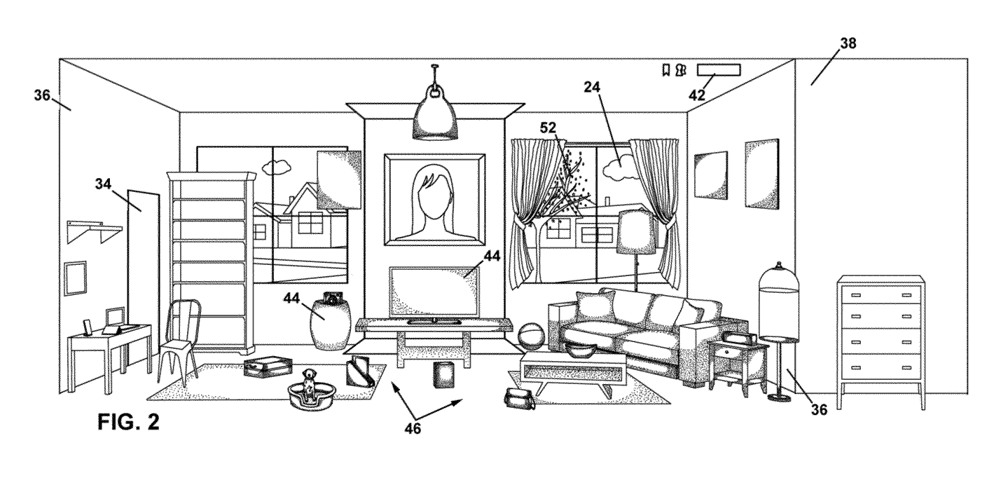

FIG. 3 illustrates the virtual representation of the Room of FIG. 2 with expanded Designer menu.

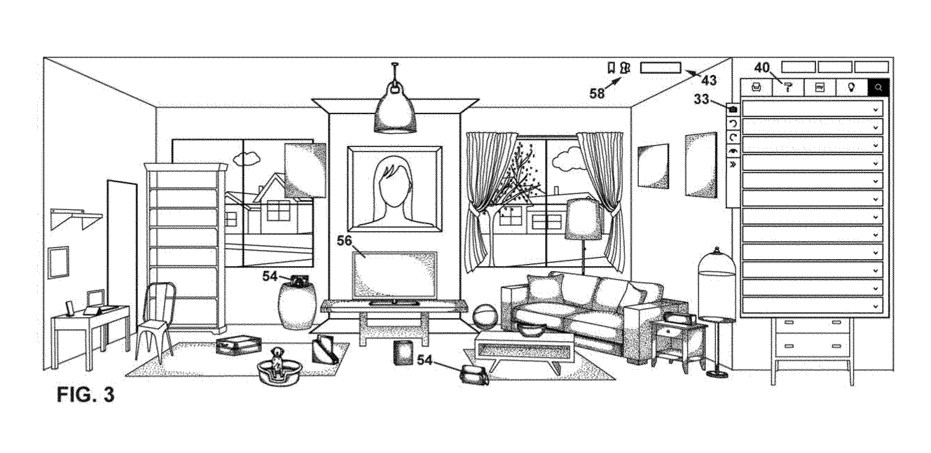

FIG. 4 Illustrates one of the preferred embodiments of the Method of the present invention.

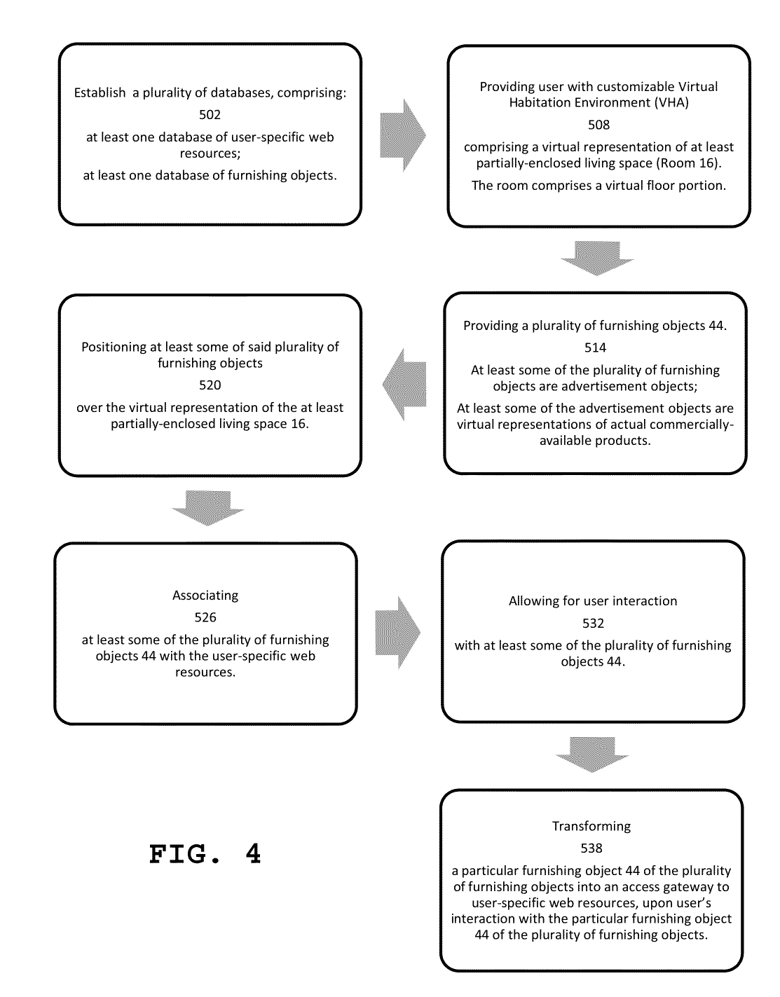

FIG. 5 Illustrates one of the preferred embodiments of the System of the present invention.

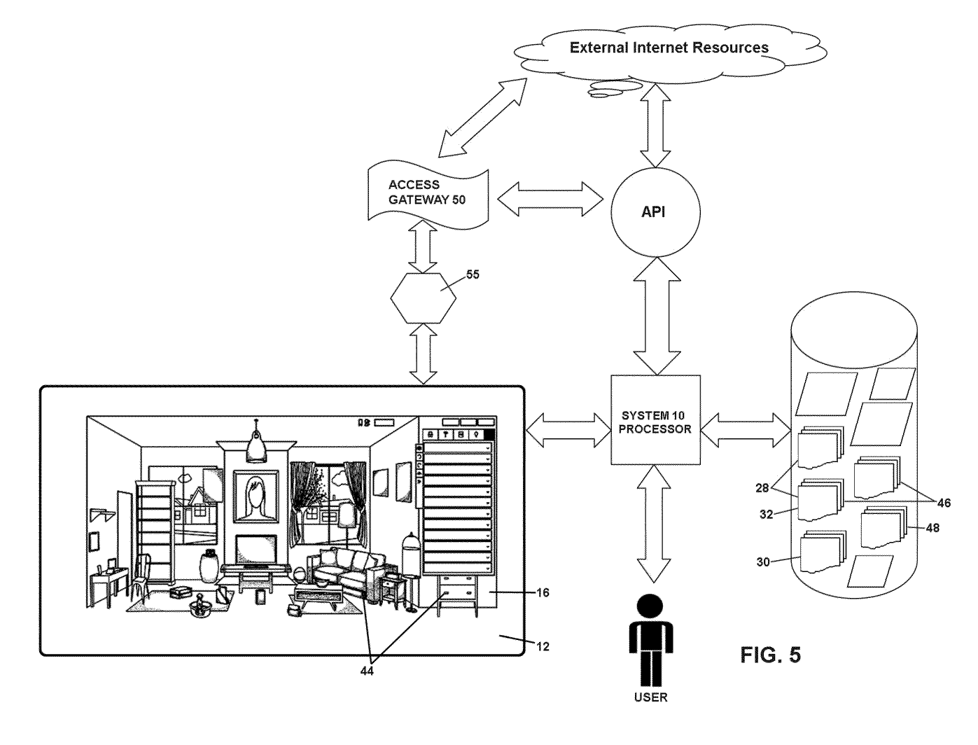

### FIELD OF THE INVENTION

The field of this invention is computer-implemented methods and systems for internet browsing and advertising, and more particularly, the computer-implemented method and system for simultaneous improvement of internet browsing and of advertising through association of virtual habitation environment and advertisement objects with user-specific web resources.

### BACKGROUND OF THE INVENTION

More than ever, the lives of modern people revolve around the online presence. Each day, an ever-increasing number our daily tasks are carried out online. We shop, play games, read the news, listen to music, share photos, watch videos, follow sports and hobbies, learn, work, design, create, socialize and carry out countless other tasks online. To carry out these tasks, we access a myriad of various internet resources.

These resources are spread out throughout the internet. Some of these resources are open, but can be difficult to find. Locations and names may be difficult to remember. Surely, there are bookmarking options in our browsers. But often, we have to switch from our desktop to a laptop, or a third-party computer at work, in the internet cafe or a hotel. Sometimes we browse from our phone. These machines have different bookmarks, browsers and operating system, making it difficult to access the resources we need. Even the same computer can have several distinct operating systems or browsers installed, each with varying bookmark databases, varying approaches to bookmarking, varying plug-ins and varying display of the same web resources.

Even if all of these issues did not exist and we were able to access the internet from the same browser and on the same computer always, we would still come across issues. The bookmarking system of most browsers is highly unintuitive. It is often a folder-based system. But folder-based system is not how most people's mind and memory naturally works. After years of bookmarking, such system swells up turns into an absolute mess. Some people end up with hundreds or thousands of unsorted bookmarks in the root directory. Others end up with bookmarks buried among hundreds of folders, within numerous levels of folder organization, never to be found again.

Other types of online information that we frequently access is protected by passwords and screennames. Some of these passwords and screennames are forced onto us by others. Some are created by ourselves. But it is often physically impossible to remember even a fraction of these secret codes. We are thus often locked out of the most important websites or have to spend considerable time and effort restoring forgotten login information.

Even if we are able to access the information we need, we then see it within the browser environment that detracts from the look of the web resource. It is the environment that was pre-selected for us by manufacturers of our operating system or by one of the very few companies that provide internet browsers. All of these browsers are very similar in function and appearance and allow little, if any customization to overall look and function. The modern user is forced to adopt to the unnatural and unintuitive browsing environment, and not the other way around.

In the process of accessing our web resources, and as we are experiencing the internet, we are often exposed to web advertisement. Nearly always, this advertisement is unwelcome. Frequently, the products and services offered are not what we are interested in. Often, the design of the advertisement is distractive and unpleasant. It interferes with our online activities by blocking a portion of the screen and slowing down our browsing experience. Sometimes, the advertisements are downright intrusive, opening up pop-up windows and redirecting browsers. More often than not, such online advertisements not only disrupt the user, but create ill will for the advertiser.

All of these things stand in the way of our enjoyment of life, which migrates more and more into the virtual world. If only our virtual life could be made as simple as the good old days. Back in those days, people could watch TV by turning on an actual TV box with a simple click, rather than searching, accessing and logging into the myriad of online video services. If a person wanted to play games, he/she would go to a particular drawer and have access to all the games stored there, rather than browse and log in to hundreds of gaming websites. If he/she wanted to read the news, they would pick up a simple newspaper, rather than access the numerous news websites.

People felt comfortable and confident in this world, because it is the world we, as people were adapted for. It is the world humans have evolved to live in for thousands of years. Our memory is adapted for associating things and experiences with locations, not web addresses. We feel a special affinity to objects, not links. We find comfort by being in a cozy personalized three-dimensional spaces, at home, rather than existing as a screennamed presence in a featureless virtual information environment.

There is a long-felt and unmet need in the art of internet browsing and advertisement industry for a three-dimensional virtual space to unify all of our web browsing experiences in a virtual space, reminiscent of a three-dimensional living space that we are all used to and comfortable in. It would be wonderful if such a virtual world could unify and remember all of our passwords and web resource access information and organize them in a way that is intuitive and convenient. There is a need for the world that could be accessed from any device, anywhere in the world, and offer similar functionality regardless of user's hardware or software installed.

There is a need for a digital world that brings back the sense of three-dimensional presence, a virtual home. The world that would once again associate our activities with locations and objects, so that they are easy to remember and understand. Perhaps such world could allow for high customization of the user's environment, so that the user creates the world and the environment that he/she is comfortable and confident in, rather than adopting to the existing online environment.

For advertisers, there is a strong need for an environment where online advertisements would not be perceived as an impediment to an online experience. Perhaps, an environment, where users welcome and intentionally select company's advertisements. A world, where users will want to choose and experience a particular product or design. A world, where an advertisement will assist the user in their internet exploration experience, and not vice versa.

An online environment, simultaneously overcoming the described impediments for both the internet users and the advertisements would be novel and revolutionary in the internet browsing and the advertising industries.

The biggest impediment to such an intuitive and beneficial system appears to be in the nature of 3-dimensional graphics. Such system would be impossible without the appearance of 3-dimensionality and virtual reality. However, 3-dimensional graphics require heavy-duty processing and high-speed connectivity, in addition to numerous plug-ins and software incompatibility issues. Such requirements would exclude numerous users, devices and locations of the modern world from utilizing such a service.

The system and method of the present invention resolves all the problems, described above. In achieving these objectives, it also provides numerous additional benefits.

### SUMMARY OF THE PRESENT INVENTION

The invention describes and claims a computer-implemented method and system for improvement of Internet browsing and advertising through association of furnishing objects in virtual habitation environment with user-specific web resource compilations.

The system and method of the present invention establish a plurality of databases. The databases comprise at least one database, comprising user-specific web resources and at least one database, comprising furnishing objects.

The invention further provides customizable virtual habitation environment. This virtual habitation environment comprises at least one virtual representation of at least partially-enclosed living space, with a virtual floor portion. The invention further provides a plurality of furnishing objects. These objects are interactive and customizable. At least some of the objects are advertisement objects. Some of them are virtual representations of actual commercially-available products. At least some of the objects are positioned over the virtual representation of the at least partially-enclosed living space.

Some of the plurality of furnishing objects are associated the user-specific web resources. The System and Method of the present invention allow for user interaction with at least some of the plurality of furnishing objects.

Some embodiments of the present invention allow for transformation of a particular furnishing object into an access gateway to user-specific web resources, upon user's interaction with the particular furnishing object. In some of the embodiments, virtual representation of at least partially-enclosed living space and at least some of the objects comprise a three-dimensional illusion.

### DETAILED DESCRIPTION OF THE PREFERRED EMBODIMENTS

The system and method of the present invention will now be illustrated by reference to the accompanying drawings. Preferred embodiments of the computer-implemented system and method for Improvement of Internet Browsing and Advertising Through Association of Furnishing Objects in Virtual Habitation Environment With User-Specific Web Resource Compilations of the present invention (referred to as the System 10, Method 10 or MyWebRoom 10) have been assigned reference numeral 10. Other elements have been assigned the reference numerals referred to below.

The computer-implemented system and method 10 is aimed at (among other things) revolutionizing the user experience of accessing, browsing and sharing of online content, while simultaneously allowing for a novel type of advertising exposure. This new type of advertising exposure is non-obstructive and, in contrast to existing online advertisements, actually enhances user's experience. At the heart of the system and method 10 is the customizable virtual habitation environment 12 (VHE 12).

The user 14 of the present invention (otherwise referred to as the tenant 14) is provided 508 with the VHE 12. The virtual habitation environment comprises a virtual representation of at least partially-enclosed living space 16. In the preferred embodiments of the invention, the virtual representation of at least partially-enclosed living space 16 appears as a three-dimensional room (otherwise referred to as room 16).

When the user 14, or tenant 14 starts using the present invention, he/she signs up online for MyWebRoom service. The system 10 provides the tenant 14 with a virtual space 16, that preferably fills up most of their computing device's screen and appears to be a three-dimensional room. In some embodiments, the room 16 extends beyond the width of the user's screen and is horizontally scrollable by the user 14 to reveal the rest of the room. In the preferred embodiments of the invention, the room 16 comprises a virtual floor portion 18 (floor 18), a ceiling portion 20 (ceiling 20) and at least one window portion 22 (window 22), said window 22 comprising a window view 24.

The virtual habitation environment of MyWebRoom 10 is intended to be highly customizable in allowing the users 14 to configure and/or select the overall look of the room 16 and its contents. While many of the rooms 16 of the VHE 12 of the preferred embodiments are expected to have the look and feel of a customary room in a residential home or in an office building, it must be noted that some rooms 16 may visually resemble a living space other than a customary room. For example, some of the at least partially-enclosed living spaces 16 may resemble such things an underground “man-cave,” carved-out in stone, a homeless person's campout under a bridge, with bridge support columns for walls and a layer of garbage for a floor, an explorer's camp in a jungle, surrounded by a wall of tall grasses, a medieval prison cell, the deck of a space ship, a ball room from a fairy tale castle, and a myriad of other “living spaces.” The spaces may be historical or futuristic, real or imagined. The interchangeably-used terms “room 16” and “at least partially-enclosed living space 16” applies to all such spaces for the purposes of the present disclosure. Similarly, in some rooms 16, the term “floor” may refer to the grass or ground and the term “ceiling” may refer to the partially or completely open sky.

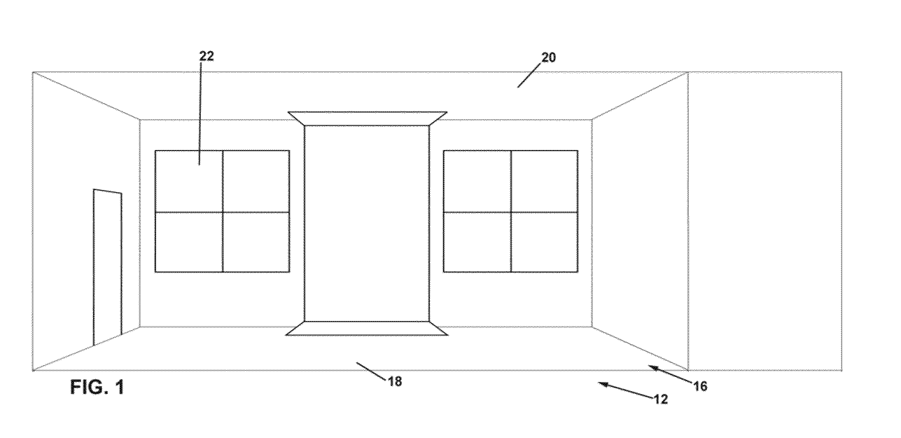

The preferred embodiment of the room 16, however, resembles an actual room. FIG. 1 illustrates one basic example of room 16. Such room 16 comprises a significantly large floor portion 18. While the size of the floor 18 may vary, in preferred variant, this portion takes up from a quarter to nearly a third or more of the vertical height of the room 16 on the user's screen. Such sizing allows for perception of depth and space and for positioning 520 of variety of virtual objects onto the floor 18, as described below.

Most rooms 16 comprise at least one, and preferably two windows 22. Again, it must be noted that in some rooms 16, the term window may refer to openings or portions of the room that appear other than traditional glass windows of modern apartments. For example, in the room that resembles a stone-age cave, the window may be a cave entrance. The windows 22 may be large or small, and in some rooms 16, extend from floor to ceiling. Preferably the window 22 comprises a window view 24. The window view 24 provides, among other functions, a sense of location of the room. Thus, one tenant 14 may elect to see the view of the Eiffel Tower from his window 22, thus creating the sense of being in Paris. Another, may choose to see the Amazonian rainforest or the Serengeti Plains. The tenant 14 of the stone-age cave may elect to see the herds of wooly mammoths from his cave opening. Preferably the window view 24 is selectable by the user 14.

The rooms 16 of preferred embodiments further comprise a ceiling 20, a side door 34, side walls 36 and side wall extension 38. However, it is foreseeable that certain embodiments of the present invention may be practiced without one or all of these elements.

The method and system of the present invention establish 502 and comprise at least one, and preferably a plurality of databases 28. In the preferred embodiments, among these databases 28 are a database comprising user-selectable virtual habitation environments 30 (room database 30) and at least one database comprising furnishing objects 32 (object database 32). Such databases are preferably stored remotely from user 14 and are located either on a cloud and/or on a server of System 10. It must be noted, however, that some embodiments of the invention may have one general database that comprises several types of data within it. In such embodiments, it may be one database that can comprise both, the virtual habitation environments, the furnishing objects and other databases and individual data. For the purposes of this disclosure, the plurality of databases may be comprised within a single general database.

The room database 30 comprises a plurality of designs for rooms 16. Once the tenant 14 starts using the present invention and “moves” into the room, the system 10 of the preferred embodiment allocates him/her a room 16. Such initial room 16 comprises a room editor control 40 (Editor 40). In the preferred embodiments, the room editor control 40 may be accessed through the Designer 42 Control link/icon, located in the top right side of the user's screen.

The room editor control comprises access to the content of the database of user-selectable virtual habitation environments. In other words, in preferred embodiments, the System 10 provides tenant 14 with access to the database 30, upon clicking on the editor 40. The System 10 allows the tenant 14 to view the content of the database 30 graphically. That is, the user 14 is able to view a number of room designs and select a design that best fits his/her tastes, mood for the day, web browsing style, and other preferences. The room design selected by the user 14 may be immediately implemented, thus transforming the virtual space from a city apartment to, say, a thatched roof but in Polynesia.

In the preferred embodiments, at least some of the room designs are created and provided by MyWebRoom 10. In some of these embodiments, it is expected that at least some of the room designs are created and uploaded by other users of System 10. In such embodiments, the virtual habitation environment comprises a room custom design upload control 33. This custom design upload control is adapted for uploading user-created designs of rooms 16 to one or more of the plurality of databases. In the preferred embodiments, the room custom design upload control 33 may be accessed through the Designer 42 Control link/icon, located in the top right side of the user's screen.

The system and method 10 further comprises and provides 514 the users 14 with a plurality of furnishing objects 44 (objects 44). These objects 44 allow for further customization and personalization of room 16 by the tenant 14. The objects 44 are intended for positioning 520 over the virtual representation of the at least partially-enclosed living space 16. That is, the objects 16 are virtual graphic images of objects intended for placement over the image of the room 16, to create a visual illusion of such objects 44 being positioned 520 inside the room 16. Both, rooms 16 and objects 44, preferably comprise a 3-dimensional illusion 46, which is claimed and discussed in detail below.

It must be noted that the term “furnishing objects,” as implemented in the present disclosure, is a broad term. It refers to a broad variety of interactive and non-interactive virtual objects 44 that may be used to furnish a room 16. The term is not limited to the objects of furniture, such as a virtual dresser or a sofa. It encompasses all objects that are part of the initial room design, or may be separately introduced into the room. The term includes such objects as the virtual pets or a window view 24, for example.

Once the tenant 14 starts using the present invention and “moves” into the room, the system 10 of the preferred embodiment allocates him/her a number of objects 44 for his/her room 16. Such default objects 44 are pre-selected by the room designer to fit the design and spirit of the room. For example, an eighteenth century room is more likely to have default furniture of rococo style, rather than of modern style. However, at least some, and preferably most of objects 44, are customizable in that they are user-selectable and replaceable.

Much like with the selection of rooms 16, above, the system 10 allows the tenant 14 to view the content of the “at least one database comprising furnishing objects 32” (object database 32) graphically. In preferred embodiments, this again is achieved by clicking on the editor 40 and now selecting the “items” tab. The System 10 then provides the user 14 with a list of graphically-displayed objects 44, available for placement into the room 16, in order to add to or replace the pre-existing objects 44. This allows the tenant 14 to highly customize the style and the type of objects 44 in his/her room, thus making each room 16 even more distinct and individual. In the preferred embodiment, any object 44, selected by the user 14 from the object database 32 may be immediately implemented and positioned “in” (i.e. over) the room 16.

Much like with the design of the rooms, at least some of the object 44 designs are developed and provided by the System 10. In preferred embodiments, at least some of the object 44 designs are created and uploaded by other users of System 10. In such embodiments, the virtual habitation environment comprises an object custom design upload control 43. This custom design upload control 43 is adapted for uploading user-created designs of objects 44 to one or more of the plurality of databases. In the preferred embodiments, the object custom design upload control 43 may be accessed through the Designer 42 Control link/icon, located in the top right side of the user's screen.

In some embodiments, the database of furnishing objects 32 (object databases 32) comprises a plurality of databases of furnishing objects 46. Preferably the furnishing objects 44 are sorted among the plurality of databases of furnishing objects 46 in accordance with the type of the furnishing object 44. For example, a plurality of databases of furnishing objects may comprise a database of lamps, a database of TVs, a database of cameras, a database of tables, sofas, and other types of objects 44.

Some of the objects 44 may be non-functional and non-interactive and may exist in the room 16 for decorative or sentimental purposes. For example, in some embodiments, such objects as a side door 34, a picture on the wall, or a custom-uploaded old toy that reminds the user 14 of his/her childhood may not carry any interactive function.

However at least some of objects 44 are interactive. That is the system and method 10 allow for some user 14 interaction 532 with at least some of the plurality of furnishing objects 44. The user 14 is able to click, tap, or otherwise select/activate an interactive object 44 in the room 16 to achieve a particular effect or function.

In the preferred embodiments of the system and method 10 of the present invention, at least some of the plurality of furnishing objects 44 are associated with 526 the user-specific web resources 48.

The term “user-specific web resources” 48 (aka user resources 48) is a broad term, referring to any web resources specifically associated with or selected by or for a particular user 14. Some non-exhaustive examples of user-specific web resources 48 (user resources 48) are a collection of particular direct internet bookmarks made by the user 16, user's 16 personal files and documents, contained in the cloud, particular types web information, preferred by the user 16, the results of keyword searches set by the users 16, information selected for a particular user 16 by System 10, and a number of other types of personalized web resources.

Whenever a user 14 interacts with a particular interactive object 44 (such as by clicking on it), the particular object 44 transforms 538 into an access gateway 50 to user-specific web resources 48. The transformation is computer-implemented, in accordance with a transformation algorithm 55 provided by the system and method 10. From the user's perspective, when such an interactive object 44 is interacted with, the object 44 is preferably transformed into a special screen. In the preferred embodiments such screen covers or replaces most or all of the view of the room. The screen comprises access to the user-specific web resources 48, such as a number or links or icons to access user's 14 bookmarks, music or documents from the cloud.

Preferably, the user-specific web resources 48 are intuitively associated with interactive objects 48 by type. For example, a camera may be associated with bookmarks to user's photo-sharing services, photo-printing services, or access to user's photo files stored on the cloud. A radio or a record player in the corner of the room 16 may best be associated with links to web resources, associated with music, such as to user's favorite compositions or performers. When the user 14 clicks on the representation of a TV, he/she may be presented with the resources that they associate with the TV, such as the links to YouTube, Netflix, Vimeo, etc., and/or particular videos on such resources. A particular user 16 may want to associate an object such as a TV with resources other than video services websites. Perhaps such user associates TV only with cooking shows and wants to have links to cooking websites, recipes and contacts with other chefs on his/her TV object. As the furnishing objects 44 are highly customizable, some variants of invention would allow such user to turn his TV object into a gateway to his world of cooking

One of the great advantages of the present invention is in allowing users 14 to organize and associate their online lives and tasks with actual objects. It allows the users to organize their lives not just in any space, but in the actual enclosed or semi-enclosed space of their choosing. The kind of space we are used to being in all our lives. The kind of space the user prefers and feels comfortable in. The kind of space that they selected themselves out of hundreds or thousands of other living spaces.

Just like in real life, the user would associate the (online) tasks and entertainment with actual objects (i.e. virtual depictions thereof). And these objects 44 are not just any objects, but the ones that the user 14 liked and selected out of thousands in the database. The user 14 will intuitively know that he/she will have to select a record player to listen to music, a TV to watch the videos, a newspaper to read the news, or an image of a pet to buy pet food or learn about pet care or events. If such user wants to know what the weather is like outside, he or she will click on the window . The user perceives and remembers web addresses and resources, just as our memory was designed to perceive and remember things over the millennia of human existence—through physical locations, through association with physical subjects. Web browsing becomes intuitive and pleasurable in such an environment.

Below is a non-exhaustive list of just a few of the types of interactive objects 44 that may be positioned in room 16 and the possible types of interaction and the types of user-specific web resources 48 that they may be associated with in preferred embodiments. The names of objects are generic and stand for a variety of designs. For example, a phone may be anything from two cans, connected by a string to a smart phone. A pet may be anything from a custom image of a real pet, to an insect, to a dinosaur, or a teddy bear, for example.

Bird Cage—links the users 14 with a social network called “Twitter”. The idea is that, a user can click on the birdcage in his room and get access to the contents from his social network. The preferred embodiments of the invention may use iFrames and API's to all the available contents from the 3rd party site, into the users room. The preferred embodiments of System 10 will provide a custom interface to show and display the data, which the user can interact with. This will include the feed, following, posting statuses and comments and other interactions allowed by the API's or iFrame.

Night Stand—features the blogging websites. Some users may associate an object like a night stand with a diary that is kept in there. Gateway to websites like Livejournal, would serve as a digital diary. The information could also be displayed using RSS feeds and API's, on a single page interface, where the contents are grouped or scattered across the page in different clickable blocks.

TV—features all the websites related to videos, television, movies, series, video news, sport streams and more. The preferred embodiments use iFrames, API's, plugins and RSS feeds to stream the contents into the user's television interface inside his/her room. This preferably includes popular websites like Vimeo and video social networks like Vine. This object also preferably allows users to store their video files from a desktop as well as mobile devices. Video sharing is also preferably allowed on social media and internally on the platform.

Music Player—may feature access to the websites related to audio files, radio stations, songs, playlists, music videos, music streaming, music sorting, music downloading, music sharing, music collaboration tools and more. The preferred embodiments use iFrames, API's, plugins, RSS feeds and other software to stream the contents into the user's music box interface inside his/her room. This object also preferably allows users to store their audio files from their desktop as well as mobile devices. Music sharing is preferably allowed on social media and internally on the platform.

Desk—a unique interface, allowing users to organize work activities such as calendars, online notebooks, communication services, research data, documents, calculator and so on. Desk may also incorporate other objects into the organization, such as Phone, Notebook, and Computer.

Phone—used as a communication tool. Users may use popular calling services such as Skype, Viber and others to call other rooms, other users within these 3rd party networks and people outside of these networks. Preferred embodiments of the method and system 10 will use API's and plugins to manage this feature. Phone may also include chat, messaging, video calling and a list of contacts, which will be synced from users active accounts online.

Notebook—used for note taking, online presentations, documents, work and school files, among other task. Users can use popular services like Evernote or a notepad integrated into the System 10. Additional features may be developed for the notebook by internal and external developers and designers.

Computer—used to organize search engines, work files and other user's online activities, which he/she may associate with the computer object.

Wall Shelf—may be used to organize user's education and learning-related bookmarks and materials. It may include links to websites like Wikipedia and Dictionary. In preferred embodiments, users can find a useful resource they are looking for or add their own, so other users can benefit from that as well. Users can link their college pages, homework's and libraries to their wall shelves in order to have a quick and organized access to them.

Pinboard—a virtual pin board, which preferably consists of user added and uploaded content, 3rd party API content and other content generated by plugins. Users can add calendars, sticky notes and everything else through the services available online. Pin board is synchronized across all platforms and devices.

Bookshelf—virtual place for magazines, books, audio books and other reading materials. Users can access their favorites from all online services by linking those thought RSS, API, Plugins and iFrames. Users can upload their own books and store them inside the interactive bookshelf. Users can access their files on any device, which supports MyWebRoom 10. Users, who write their own books can used their bookshelves to promote them and have other users vote and leave editing suggestions, both anonymously and publicly.

Hobbies—the object which incorporates websites, ads and other information related to the user's hobbies. This object is very customizable and most of the content is user generated. The preferred embodiments will offer various design templates to help user organize activities and contents associated with these activities. The contents include but are not limited to: photos, music, videos, websites, articles, social networks, calendars and apps. Some embodiments of System 10 may employ 3rd party API's to link wearable devices to user hobby object.

Box—a storage object, into which a user may collect info from the 3rd party cloud services via API's. The Box may organize these for the user in an intuitive and easy to use interface. The preferred embodiments of the System 10, also comprise an internal cloud capacity, allowing for storing and managing all the files saved inside the system of the present invention.

Newspaper—an aggregator of the news available online. Users can discover new resources or save their favorite bookmarks. A unique interface, allows viewing multiple articles, commenting, sharing, adding and snapshotting content. Users can add their own resources and share them with the whole network.

Game—a visual collection of gaming platforms, websites, apps and pages available online. This object logs the user into all of his gaming worlds and provides reminders and news on most recent activities.

TV Stand—an object where the user can store his movies and videos and build a collection that may be shareable with the other users.

Shopping Bag—provides access to user's favorite stores and suggests exploration of new websites, apps, sales and special events. In some embodiments, users may get notifications from the favorite stores, which they follow. Users can use the object to save receipts for purchases. Users can use universal shopping cart to shop and check out on many different sites simultaneously. The shopping bag may save the users CC information for ease of future purchases.

Dresser—a collection of e-commerce websites and recommendation websites to learn about new trends, follow favorite designers and shop online for clothing.

Pet—a virtual avatar of a pet, which acts like an assistant in the room. The user can feed the pet, move him around the room, or allow free movement. The user can access pet-related content online. In some embodiments, this object may provide access to help section of the website.

Chair—allows the user to discover new content, by providing new updates on a daily basis. A feature called ‘Spin in my Chair”, allows the user to discover new things on the Internet based on what the user's pre-set or pre-determined interests.

Food—Collection of cooking websites, restaurant recommendations, reservations, reviews, food magazines and shows, locations, health advice and dieting. Visual collection of food related services. This object may act as an online kitchen for the user.

Sports—a collection of websites and apps related to sports. Users may get aggregated sports news and other contents based on their interests. The interests may be preset by choosing and saving user's favorite websites and apps. The preferred embodiments of the present invention use iFrames to open websites, API's to aggregate contents, and RSS feeds to provide the user with headlines and top news. Users can also use plugins and streaming services to watch their favorite sports events live or recorded.

Portrait—allows for customization and editing of user's profile and picture.

World Map—Provides aggregated access to various travel services, including booking and discovery. The object may provide information and booking for hotels, cars, airlines, apartments, as well as reviews and recommendations. It is also a place for finding and exploring various maps, trails, driving directions more. Some of the of the functionality of the preferred embodiments may be based on 3rd party API's.

Social Canvas—aggregation of social networks. Access to all the users networks via a single click on a visual icon, which represents a network outside of System 10. API's will be used to pull information and display it inside this object's interface for the user. In the preferred embodiment, a user may go to his/her friend's room and access all of the user's public accounts via one click if he/she has a permission to do that.

Camera—aggregates, stores, and provides access to user's photo/image content from all over the web, user's mobile apps and personal uploads. This object allows the user to store files and to create custom albums and collages. 3rd Party API's, mobile and desktop uploads allow for pulling of information from all the existing resources into one image-related interface, created and customized by the user.

Window 22—a unique object, which in preferred embodiments allows users to keep up with the events related to their location. In some embodiments, the location may be either that of the user or the virtual location of the room. Window may provide users with local weather, local coupons (Groupon.com), calendar, world clock and other local information such as local things-to-do. Users can add the websites they would like to use. Based on the user IP address (if he/she allows for the system to use their “current location”), the system 10 can display a picture, taken from Google Maps Street View (or other similar service), of their particular location. This will create an effect of looking outside, through the window, as if from a real room.

In some preferred embodiments of the present invention, some of the furnishing objects 44 comprise variable appearance 52. The term “variable appearance” refers to the change in appearance of one or more objects 44 in response to the external factors. One example of an object 44 with variable appearance in some embodiments, is the window 22 object, described above.

In the case of the window 22 and window view 24, variable appearance 52 may be applied as follows. System 10 would use geo-location or information from the user's profile to determine user's time zone and location. This would allow the system 10 to change the timing (daylight, sunrise, sunset, night time) and apply variable appearance 52 to subjects within the room 16. In this case, the external factor will be the time of the day. For example the user may be located in Manhattan N.Y. It is currently 8 pm on a December night. Accordingly, the window view 24 would display an evening view. An associated object with variable appearance 52, such as a chandelier on the ceiling of the room 16 may light up. As it gets later, perhaps the view would change to a night view—with fewer lights and reduced traffic. In the morning, the user may observe a bright morning view on/through the windows view object 24. A nearby object, such as the window 22 may also be brighter. Thus, the object will change, with changing external conditions. In some embodiments, the an object 44, such as the window view 24 will also change with the change in the seasons, weather and temperature (received by system 10 from outside internet sources). A number of objects 44 may comprise variable appearance 52. For example, in some embodiments a TV may turn on, or display a certain image when the user's favorite show is on, or when a new video is added to user's subscribed channel on YouTube.

The virtual representation of at least partially-enclosed living space 16 comprises a three-dimensional illusion 46. The three-dimensional illusion 46 is an important and very distinctive concept of the present invention. In the preferred embodiments of the invention, the three-dimensional illusion is not limited to the room 16. In these embodiments, at least some, and preferably most, of furnishing objects comprise a three-dimensional illusion.

From the perspective of the user, the room 16 and all the objects 44 within it appear three-dimensional. There is an appearance of realistic depth and perspective to the room 16 and the objects 44 within it. In part, it is this perceived realism that makes the use of the System 10 so intuitive and pleasurable to use. To the tenant 14, it appears that he/she is submerged into a three-dimensional virtual reality world of high-end video games. However, they are not. The 3-dimensionality of the System 10 is an illusion. Hence the term—“three-dimensional illusion” 46.

The applications, especially web-based applications that employ real 3D engine require considerable processing power and very fast connection speeds for smooth functionality. They also often require special plug-ins that may be unavailable on certain platforms.

The system and method 10 of the present invention make use of two-dimensional, flattenened-out graphics for both the rooms 16 and the objects 44. The objects are strategically designed and positioned, so as to create the sense of perspective. To achieve this effect in the preferred embodiments, the furnishing objects are associated by type of the furnishing object. That is, an object is identified by type, such as a tv-type object, a telephone-type object, a camera-type object, a computer-type object, a sofa-type object, etc.

Each type of a furnishing objects is then associated with a particular location on the virtual representation of the at least partially-enclosed living space 16. That, is, each object is associated with a special position reserved for that type of object. Thus, the place for all types of couches/sofas may be reserved in the right side of the room, while any type of a TV object will be placed at the particular TV location, between the windows. In the preferred embodiments, the user's 14 movement inside the room is limited (in preferred embodiments it is limited to movement to the left and to the right), so as not to disturb the three-dimensional illusion.

The result of this unique set-up is the system that allows the tenant 14 to access his room from nearly any device connectable to the internet, be it an older computer or a smart phone. As there are no special plug-ins to install, the user's operating system and browser are nearly irrelevant. As there is no need for 3-D processing, the room 16 and the objects 44 load quickly and smoothly, allowing the tenant 14 to access his/her room from any device anywhere in the world. The unique three-dimensional illusion 46 approach, thus gives a the system and method 10 a tremendous competitive advantage over true 3-D based projects which are built on technologies such as Unity3D and similar.

The method and system 10 of the present invention works exceptionally well with CPC, CPM, CPA and other known marketing models. However, the present invention also provides for truly unique advertising opportunities. It provides for very personal, unobtrusive, unobjectionable and overall organic interaction between the user and the advertisement.

In the preferred embodiments of the present invention, at least some of the plurality of furnishing objects 44 are advertisement objects 54. The advertisement objects may be functional as well as non-functional objects 44. Some of the advertisement objects may be designed into certain rooms 16 by the initial designers. The room may comprise certain trademarks in its decor or non-functional objects by a particular company. For example, a certain room design may incorporate window-shades or distinctive furniture by a particular well-known brand. Since the user 14 selects a room 16 based on personal tastes and preferences in design and decoration, the included advertisement objects are likely to be perceived positively by the user 14. After all, in this case, the advertisements were chosen by the user, and not the other way around, as usually happens with advertisements.

The positive effects of this “user-selected” approach to advertisement are further enforced when the user 14 not only selects the room with the advertising object, but proactively selects the advertising object and places it in his/her room. In the preferred embodiments of the invention, the database, comprising furnishing objects 44 comprises a plurality of advertisement objects 54. Some of these advertising objects 54 are actual framed advertisement images or advertisement objects. Others may be the latest electronics or fashion products.

It is a well known custom to decorate certain kinds of living spaces with old and/or interesting advertisements. While many tenants 14 will perceive and treat such objects as interesting decorations, as objects of beauty and comfort, such decorations in the tenant's virtual room may be of great value to the companies behind these advertisements. This is particularly true, since it were the users 14 that liked and selected the advertisements for their room from a list of thousands of objects 44. The advertisements are thus likely to be far less obtrusive and far more effective than regular advertisements, forced by the company onto the consumer. If a particular advertisement object 54 is a functional object 44, its effect on the user 14 and value of such advertising to the company will be even greater. In this case, not only will the user be constantly exposed to the advertisement he/she selected, but will regularly obtain use and pleasure by clicking on a particular trademark or product.

In the preferred embodiments of the present invention, at least some of the advertisement objects 54 are virtual representations of actual commercially-available products 56. Thus, the user may select, from the database of furnishing objects, the actual products available on the market today. For example, a particular user 16 may elect to have a the latest model of a particular TV, or the high-end digital camera, or a particular sofa as an object 44 in his/her room 16. This may be an object that the tenant 14 is saving up to buy in real life, or an object, the look and feel of which the tenant 14 likes. Once placed in the room 16, such an object serve as a constant reminder to the user who wants to buy it. Alternatively, the user who selected the object for its aesthetic beauty, without intent to buy, may get used to seeing and interacting with the object in the virtual world, and will be more likely to purchase the actual item for his real-world home or office. One of the unique aspects of the present invention is in that it allows the user 14 to discover and try actual products in the virtual world, without any financial liability. Some of these are likely to be the products that the user 14 would never have even discovered, much less considered buying in the real world. This aspect is equally advantageous to the user 14 and to the advertisers.

Fortunately, the preferred embodiments of the present invention provide an opportunity to buy such favored item either directly through system 10 or by providing a link to a retailer or a manufacturer. This novel method of advertisement is natural, non-obtrusive, and extremely powerful.

In some embodiments of the invention, the virtual habitation environment 12 (VHE 12) may be limited and may only comprise the room 16 and its necessary components. In other, preferred variants, it may be thought of as a virtual geographical area, a virtual world, a building, or a neighborhood, comprising a great number of rooms 16 and a plurality of goods and services for the users. In the preferred embodiment of System 10, the rooms 16 number in millions. Most of the rooms are unique and reflect their user's tastes and personalities. Some of the rooms 16 are stand-alone virtual spaces. Other rooms 16 are interconnected in one or more ways by user's personalities, tastes, interests, etc.

In order to provide interaction between various tenants 14, in the preferred embodiments of the invention, the customizable virtual habitation environment comprises shareable accessibility element 58. In the preferred embodiment, this accessibility element is referred to as a “key request” or “key sharing”

The concept of the shareable accessibility element 58 adds an element of social networking to the present invention. Each room 16 uniquely represents the user, his/her interests, tastes, creativity, shopping and learning patterns, etc. While some users may want to keep such information private, others may want to open the doors of their room and invite/share it with friends.

In some embodiments, the key request may be made by “knocking on the door” of another user 14. The user 14 may then approve a specific “Key Request” by providing a key and granting room access to another resident of the virtual habitation environment. By allowing others into their rooms, the users 14 are able to share content such as videos, photos, music, links, text, files and everything else, through cloud computing. The sharing and interconnectivity would be accomplished by utilizing 3^{rd} Party API's provided by popular existing and future services.

The preferred embodiments of the invention also allow for the variable degree of sharing, depending on who asks for the key. Since, some embodiments of the System and Method 10 of the present invention are intended as a unifying space for all of the user's online activities, protected by one universal-login (password into the system 10), a universal key may open the doors to all of the user's social media sites and other private online content.

Thus, in the preferred embodiments, the users are able to set the degree of sharing, regarding the types or specific items of information they would share with a particular group or person. The present invention allows for varying appearance and functionality of the same room, depending on who is using it. For example, the system of the present invention allows for a room to appear differently to family, friends or colleagues, and to allow access to varying types of resources to various visitors. This is preferably achieved by utilizing the JavaScript coding language, which allows the system 10 to determine which particular user is visiting which room. Once that is identified, the system's code would filter the contents, based on the permissions guided by the RoR backend.

Naturally, the users receiving the keys will be exposed to advertising content and advertising objects in the room they are visiting. It is foreseeable by the present invention that companies may create advertisement or informational rooms and share the keys to such rooms with other users. For example, an electronics company may want to create a room that is a museum of their old products and advertisements, a showcase of the newest releases and generally submerges the user into the world of the company.

Further on, users can utilize the accessibility element 58 to get together to build entire communities by joining their rooms 16 together into building blocks and virtual residential areas. Such residential areas may comprise lounges, classrooms, with actual classes offered by actual professors, offices with productivity tools, retail stores, etc. The present invention allows for all of this and more, by utilizing the elements described above and claimed below.

It is to be understood that while the system and method of this invention have been described and illustrated in detail, the above-described embodiments are simply illustrative of the principles of the invention and the forms that the invention can take, and not a definition of the invention. It is to be understood also that various other modifications and changes may be devised by those skilled in the art which will embody the principles of the invention and fall within the spirit and scope thereof. It is not desired to limit the invention to the exact construction and operation shown and described. Nor is it desired to limit the method steps described in the description and/or the claims below to a particular order of execution. The spirit and scope of this invention are limited only by the spirit and scope of the following claims.

I claim:

1. The computer-implemented method for improvement of Internet browsing and advertising through association of furnishing objects in virtual habitation environment with user-specific web resource compilations;
the method comprising the steps of:
A. establishing a plurality of databases, wherein the plurality of databases comprises:
a. at least one database, comprising user-specific web resources;
b. at least one database, comprising furnishing objects;
B. providing customizable virtual habitation environment,
said virtual habitation environment comprising:
a. at least one virtual representation of at least partially-enclosed living space,
b. said at least one virtual representation of at least partially-enclosed living space comprising a virtual floor portion,
C. providing a plurality of furnishing objects,
wherein at least some of said plurality of furnishing objects are interactive;
wherein at least some of said plurality of furnishing objects are customizable;
wherein at least some of the plurality of furnishing objects are advertisement objects;
wherein at least some of the advertisement objects are virtual representations of actual commercially-available products;
D. positioning at least some of said plurality of furnishing objects over the virtual representation of the at least partially-enclosed living space;
E. associating at least some of the plurality of furnishing objects with the user-specific web resources;
F. allowing for user interaction with at least some of the plurality of furnishing objects.

2. The method of claim 1, further comprising the step of:
transforming a particular furnishing object of the plurality of furnishing objects into an access gateway to user-specific web resources, upon user's interaction with the particular furnishing object of the plurality of furnishing objects.

3. The method of claim 2,
wherein virtual representation of at least partially-enclosed living space comprises a three-dimensional illusion;
wherein at least some of said furnishing objects comprise a three-dimensional illusion.

4. The method of claim 3, wherein:
the plurality of databases further comprises a database comprising user-selectable virtual habitation environments and
wherein the plurality of furnishing objects comprises at least four furnishing objects.

5. The method of claim 4,
wherein most of the plurality of furnishing objects are user-selectable.
wherein most of the plurality of user-selectable furnishing objects are interactive and
wherein most of the plurality of user-selectable furnishing objects are advertisement objects.

6. The method of claim 4, wherein the at least one database of furnishing objects comprises a plurality of databases of furnishing objects, wherein the furnishing objects are sorted among the plurality of databases of furnishing objects in accordance with the type of the furnishing object.

7. The method of claim 3, wherein the virtual representation of at least partially-enclosed living space comprises a ceiling portion and at least one window portion, said window portion comprising a window view.

8. The method of claim 7, wherein at least one of the plurality of user-selectable furnishing objects comprises variable appearance.

9. The method of claim 4, wherein the customizable virtual habitation environment comprises shareable access.

10. The method of claim 4, wherein the customizable virtual habitation environment comprises a room editor control, said room editor control comprising access to database of user-selectable virtual habitation environments.

11. The method of claim 10, wherein the virtual habitation environment comprises a custom design upload control, said custom design upload control adapted for uploading user-created furnishing objects to one or more of the plurality of databases.

12. The method of claim 3, wherein at least one virtual representation of at least partially-enclosed living space comprises a plurality of virtual representations of at least partially-enclosed living space.

13. The method of claim 3,
wherein the furnishing objects are associated by type of the furnishing object,
and wherein each type of a furnishing object is associated with a particular location on the virtual representation of the at least partially-enclosed living space.

14. The computer-implemented system for improvement of Internet browsing and advertising through association of furnishing objects in virtual habitation environment with user-specific web resource compilations;
the system comprising:
A. a plurality of databases, wherein the plurality of databases comprises:
a. at least one database, comprising user-specific web resources;
b. at least one database, comprising furnishing objects;
B. virtual habitation environment,
said virtual habitation environment comprising:
a. at least one virtual representation of at least partially-enclosed living space,
b. said at least one virtual representation of at least partially-enclosed living space comprising a virtual floor portion,
C. a plurality of furnishing objects,
wherein at least some of said plurality of furnishing objects are interactive;
wherein at least some of said plurality of furnishing objects are customizable;
wherein at least some of the plurality of furnishing objects are advertisement objects;
wherein at least some of the advertisement objects are virtual representations of actual commercially-available products;
D. wherein at at least some of said plurality of furnishing objects are positioned over the virtual representation of the at least partially-enclosed living space;
E. wherein at least some of the plurality of furnishing objects are associated with the user-specific web resources;
F. further comprising an algorithm for transforming at least one of the interactive furnishing objects of the plurality of furnishing objects into an access gateway to user-specific web resources, upon user's interaction with the particular interactive furnishing object of the plurality of furnishing objects.

15. The system of claim 14,
wherein virtual representation of at least partially-enclosed living space comprises a three-dimensional illusion;
wherein at least some of said furnishing objects comprise a three-dimensional illusion.

16. The system of claim 15,
wherein the at least one database of furnishing objects comprises a plurality of databases of furnishing objects, wherein the furnishing objects are sorted among the plurality of databases of furnishing objects in accordance with the type of the furnishing object;
and wherein each type of a furnishing object is associated with a particular location on the virtual representation of the at least partially-enclosed living space in accordance with the type of the furnishing object.

17. The system of claim 15, wherein the virtual representation of at least partially-enclosed living space comprises a ceiling portion and at least one window portion, said window portion comprising a window view.

18. The system of claim 14, wherein at least one of the plurality of user-selectable furnishing objects comprises variable appearance.

19. The system of claim 4, wherein the customizable virtual habitation environment comprises shareable access.

20. The system of claim 4, wherein the virtual habitation environment comprises a room editor control, said room editor control comprising access to database of user-selectable virtual habitation environments, and
a custom design upload control, said custom design upload control capable of uploading user-created furnishing objects to one or more of the plurality of databases.
